(19) United States
(12) Patent Application Publication
(10) Pub. No.: US 2006/0035745 A1
(43) Pub. Date: Feb. 16, 2006

(54) System for producing gearboxes

(75) Inventors: Manfred Wittenstein, Mergentheim (DE); Thomas Bayer, Igersheim (DE)

Correspondence Address: BACHMAN & LAPOINTE, P.C., 900 CHAPEL STREET, SUITE 1201, NEW HAVEN, CT, 06510, US

(73) Assignee: WITENSTEIN AG, IGERSHEIM (DE)

(21) Appl. No.: 10/519,667

(22) PCT Filed: May 15, 2003
(86) PCT No.: PCT/EP03/05100

§ 371 Date: Dec. 28, 2004

(51) Int. Cl. F16H 57/08

(52) U.S. Cl. 475/331

(57) ABSTRACT

A system which is used to produce gearboxes and consists of various components (M, A_{M}, A₁, A₂, A₃, Hₐₙ, H_{ab}, A_{E}). A SP kinematics or TP kinematics gearbox can be produced by mounting a different assembly of the component (Hₐₙ) and the components (H_{ab}) and (A₂).

### BACKGROUND OF THE INVENTION

The invention relates to a system for producing gearboxes, which consists of different subassemblies.

There are known gearboxes which consist of one, two or, where appropriate, three casing parts and have corresponding stages, transmission stages, etc.

Furthermore, in gearboxes, there are kinematics known as SP or TP kinematics. The individual gearboxes are designed as construction series, for example in SP kinematics or in TP kinematics. In this context, either only long, straight gearboxes can be produced for a specific construction series or short, thick gearboxes, for example as TP gearboxes, can be produced with completely different subassemblies.

There are therefore only different basic construction types, gearboxes with different kinematics.

The object on which the present invention is based is, therefore, to provide a system of the type initially mentioned, which can be used universally and in which subassemblies for the most diverse possible kinematics and basic construction types of gearboxes can be used at least partially.

At the same time, the number of subassemblies for any desired types is to be minimized, while different kinematics, transmission ratios or power flows are to be implemented. Furthermore, for a reduction in manufacturing costs, the parts are to be reduced.

### SUMMARY OF THE INVENTION

To achieve the object, a gearbox having SP kinematics or TP kinematics can be assembled by means of a different mounting of the subassembly (Hₐₙ) with the subassembly (H_{ab}) and (A₂).

In the present invention, by means of the essential core subassemblies, such as, for example, the engine, the engine adapter plate, the hollow shaft wheel of the output stage, the ring wheel of the drive stage and the output unit, designed as an output shaft or output flange, single-stage, two-stage or three-stage gearboxes with different output units can be produced. In this case, the output unit is to be designed as an output shaft or as an output flange.

Furthermore, in the present invention, it is important that, by means of different mounting operations a corresponding different connection of the ring wheel of the drive stage to one side of a universal planet-wheel carrier of the output stage, a gearbox according to TP kinematics can be produced, or, by means of another mounting operation, the ring wheel of the drive stage can be screwed to the stationary casing, in order to produce a gearbox with SP kinematics.

In this case, all the gearboxes can be assembled as TP or SP gearboxes with the same core subassemblies, without in addition other additional subassemblies being required.

At the same time, in the universal system or universal construction kit, in each case a single-stage, two-stage or three-stage gearbox can be produced selectively by means of units.

As a result, the number of all these subassemblies for different gearbox kinematics and different gearbox types, whether long or short or TP or SP gearboxes, is reduced considerably.

At the same time, different kinematics and also transmission ratios and power flows can be implemented by means of one and the same subassembly.

Furthermore, the individual subassemblies or casing parts can be screwed or welded to one another, adhesively bonded to one another or connected to one another by positive connections. That is to say, furthermore, even customer-specific gearboxes, particularly with regard, for example, to flanges, shafts, output flanges, sensors or the like, can be specified very easily, since only this subassembly of the output unit or of the output shaft or of the output flange has to be specified and adapted. All the remaining subassemblies can preserve their original form in order to produce a single-stage, two-stage or three-stage gearbox in the TP or the SP version.

Also, corresponding individual subassemblies of the output shaft or of the output flange can be provided, for example, with corresponding sensors or the like. This is likewise to come within the scope of the present invention.

In particular, the choice of the output subassemblies or of the output units is particularly suitable for specifying gearboxes with special customer-specific modifications or the like.

It is also conceivable, if appropriate, to flange different engines and mounted parts to single-stage, two-stage or three-stage gearboxes designed as SP or TP gearboxes. This gives rise to a universal system, in particular a universal construction kit, which ensures that the individual subassemblies can be constructed in one and the same number of subassemblies in order to produce gearboxes with different kinematics, different selectable transmission ratios and different gearbox versions or different gearbox types as SP or TP construction series. This saves considerable manufacturing costs and ensures that the user can himself construct a gearbox in a user-specific way.

### BRIEF DESCRIPTION OF THE DRAWINGS

Further advantages, features and details of the invention may be gathered from the following description of preferred exemplary embodiments and with reference to the drawing in which:

FIG. 1a shows a diagrammatically illustrated arrangement of individual subassemblies for the production of different gearboxes, in particular for the production of a single-stage, two-stage and three-stage gearbox;

FIG. 1b shows diagrammatically illustrated views of a kinematic plan of an SP gearbox and of a TP gearbox;

FIGS. 2a and 2b show diagrammatically illustrated top views of an engine and of an adapter plate for an engine;

FIGS. 3a and 3b show diagrammatically illustrated longitudinal sections through two different mounted parts with clamping hubs and with an integrated sun wheel;

FIG. 3c shows a diagrammatically illustrated longitudinal section through a further mounting part with an integrated sun wheel and planet wheel;

FIG. 4 shows a diagrammatically illustrated longitudinal section through the component as the ring wheel of the drive stage;

FIG. 5 shows a diagrammatically illustrated longitudinal section through a further component as the hollow shaft wheel of the output stage;

FIGS. 6a and 6b show diagrammatically illustrated longitudinal sections through output units designed as an output flange A_{F} or output shaft A_{W}.

### DETAILED DESCRIPTION

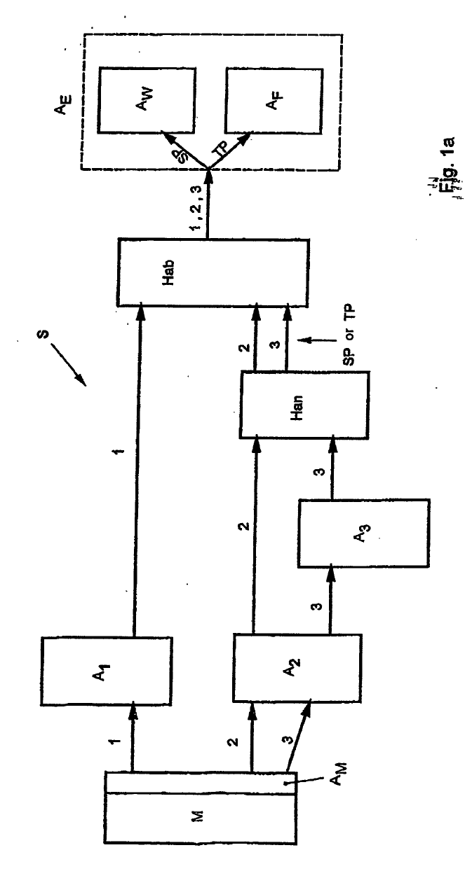

According to FIG. 1a, a system S according to the invention for the production of different gearboxes, single-stage, two-stage or three-stage gearboxes, shows different possibilities for assembling a single-stage or two-stage or three-stage gearbox from different subassemblies, and in this case certain identical subassemblies can be used in each gearbox.

Each gearbox may also be used as a subassembly of components with an engine M, if appropriate an engine adapter plate A_{M}, and also the hollow shaft wheel H_{ab} and an output unit A_{E}, illustrated here by broken lines.

In this case, the hollow shaft wheel of the output stage H_{ab} may be followed selectively as an output unit A_{E} by an output shaft A_{W} or an output flange A_{F} as a subassembly.

If a single-stage gearbox is to be produced, the subassemblies, engine and, if appropriate, adapter plate A_{M}, are added to a first mounted part A₁, then the hollow shaft wheel of the output stage H_{ab} and finally any desired output unit A_{E}. Either, the output shaft A_{W} or output flange A_{F} are attached as an output unit A_{E} to the hollow shaft wheel of the output stage H_{ab}. The design of the output unit A_{E} can be selected customer-specifically and can also be changed customer-specifically.

This gives rise to a single-stage gearbox which can be modified customer-specifically especially in the region of the output unit A_{E}. For example, any desired flanges, special versions of shafts, sensors or the like in these subassemblies may be modified, or these may be varied correspondingly.

These are then fitted onto the subassemblies, engine M and mounted part A₁, or, in particular, onto the hollow shaft wheel of the output stage H_{ab}.

In order to obtain a two-stage gearbox, the engine M, if appropriate the engine adapter plate A_{M}, is again likewise connected to a second mounted part A₂ to which a ring wheel of the drive stage Hₐₙ is attached. The hollow shaft wheel of the output stage H_{ab} is then attached to this ring wheel in the way described above, and, once again, depending on the customer requirement and particular embodiment, any desired drive unit A_{E} may be designed as an output shaft A_{W} or as an output flange A_{F} in the way described above. It is important, here, that, at least in the version of a single-stage or two-stage gearbox, at least the subassemblies, engine M, engine adapter plate A_{M} and hollow shaft wheel of the output stage H_{ab} and, selectively, the output unit A_{E}, can be used again, without changes, as the same subassemblies.

In order to obtain a three-stage gearbox, in the case of a corresponding construction of the two-stage gearbox, a further mounted part A₃ merely has to be inserted between the subassemblies, mounted part A₂ and ring wheel of the drive stage Hₐₙ.

Depending on the customer requirement and the design of the three-stage gearbox, any desired drive unit A_{E} as a drive shaft A_{W} or as a drive flange A_{F} can then be selectively attached to the hollow shaft wheel of the output stage H_{ab} in the way described above.

In order to produce a single-stage, two-stage or three-stage gearbox by means of these few subassemblies, the respective marked subassemblies having to be connected in each case correspondingly to 1 for a single-stage, 2 for a two-stage or 3 for a three-stage, different gearboxes can be assembled.

Thus, a two-stage or three-stage gearbox can be produced in a modular manner by means of a minimum number of subassemblies. The individual subassemblies merely have to be screwed, welded or joined to one another or otherwise connected to one another. The invention will not be restricted to this.

Furthermore, it is advantageous that, in particular by the selection of drive unit A_{E} as drive shaft A_{W} or drive flange A_{F}, long or short gearboxes with specific shafts or flanges can be produced so as to be single-stage or multistage. Different transmission ratios and power flows can thereby be implemented by means of different kinematics as TP or SP.

As a result, gearboxes can be produced universally, and gearboxes which are of different types and which possess different kinematics can be produced by means of the same essentially identical subassemblies. This is implemented merely by means of a very limited number of subassemblies as a universal construction kit. At the same time, the different gearbox types can be produced, single-stage, two-stage and three-stage, as SP to TP gearboxes from subassemblies. Thus, not only the gearbox type, but also the desired size of the gearbox and the desired kinematics of the gearbox can be varied customer-specifically and be produced individually by means of one and the same component.

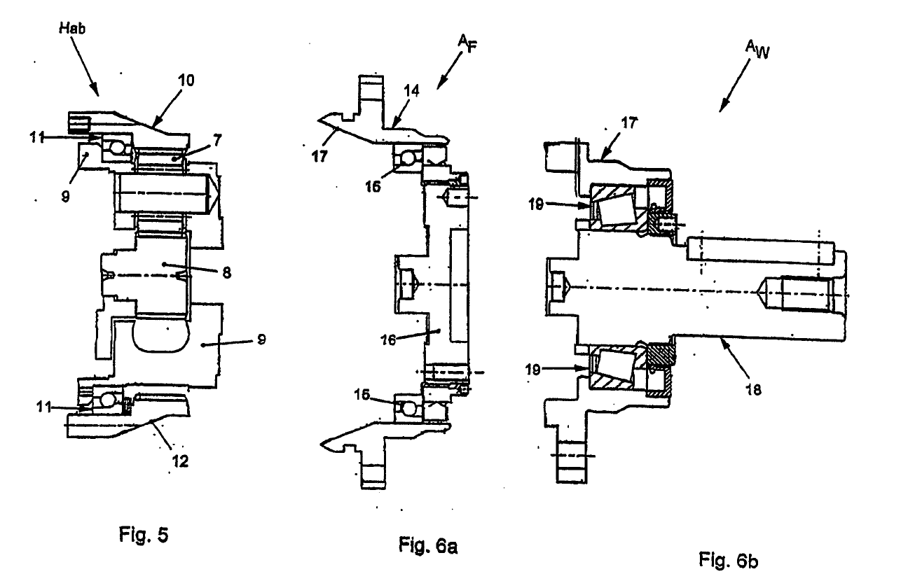

To produce a two-stage TP gearbox, the ring wheel 20 of the ring wheel of the drive stage Hₐₙ, see FIG. 4, is firmly connected, in particular firmly screwed, to the universal planet-wheel carrier 9 of the hollow shaft wheel H_{ab} of the output stage, see FIG. 5.

To produce a two-stage SP gearbox, a ring wheel 20 of the ring wheel of the drive stage Hₐₙ is firmly connected, in particular firmly screwed, to the stationary casing part 3 of the mounted part A₂ by means of another mounting operation.

In this case, the same subassemblies, hollow shaft wheel of the output stage H_{ab} and ring wheel of the drive stage Hₐₙ and also mounted part A₂, can be used in order to produce either an SP or a TP gearbox. What is important here is only the different mounting operation of the individual subassemblies in order to obtain different kinematics by means of one and the same subassembly here.

The individual subassemblies for producing the different gearboxes are described below as follows:

The different kinematics of an SP gearbox or of a TP gearbox are illustrated diagrammatically in FIG. 1b. The kinematic plan of an SP gearbox shows different transmission ratios from that of a TP gearbox. Particulars of the kinematic plan of the SP and TP gearbox are not dealt with in any more detail, since this is known in the prior art.

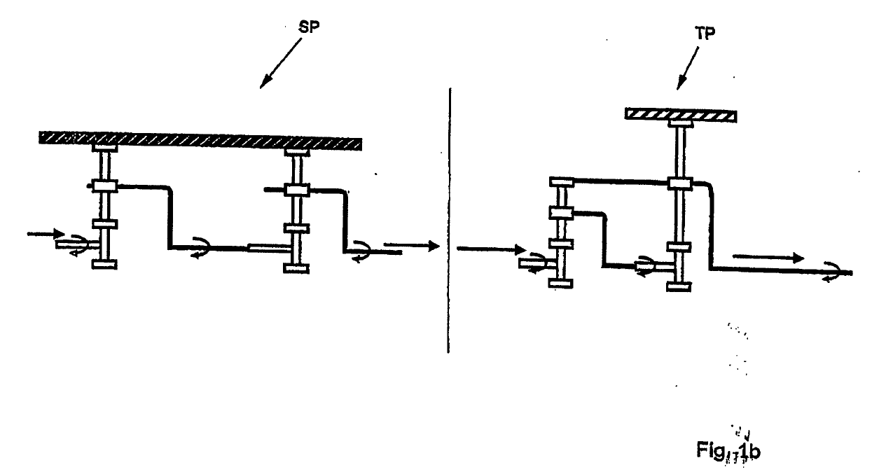

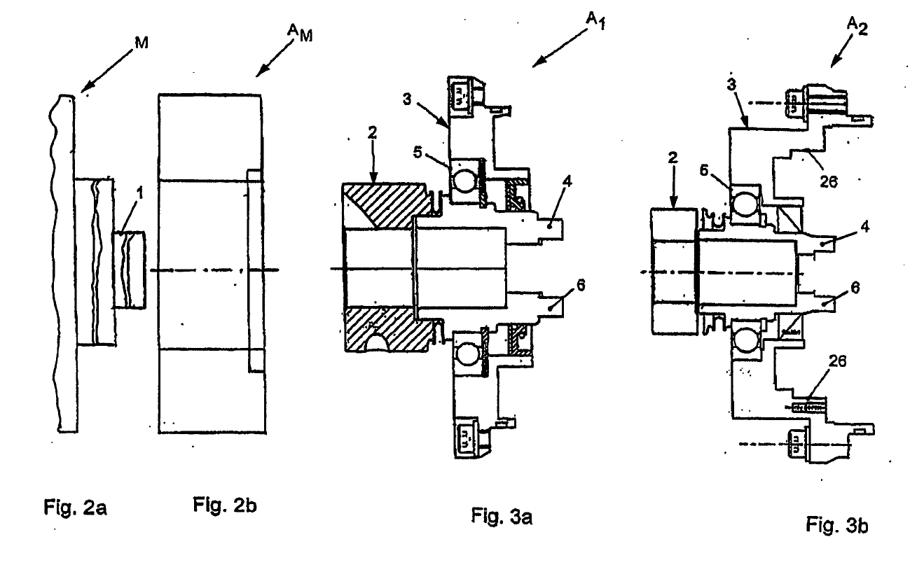

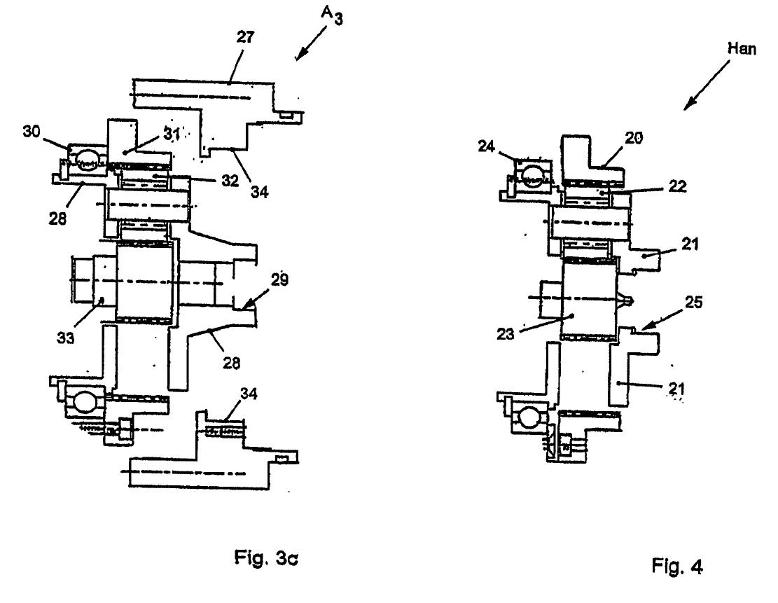

According to FIG. 2a, any desired engine M can be directly connected by means of an engine shaft 1 to a mounted part A₁ or A₂, as illustrated particularly in FIGS. 3a and 3b. If appropriate, an engine adapter plate A_{M} is inserted between them, in which case the engine adapter plate A_{M} can be connected to the mounted parts A₁ or A₂.

The engine shaft 1, merely indicated here, engages into a corresponding clamping hub 2 of the subassemblies A1 or A2. The mounted part A1 or A2 has, in addition to a clamping hub 2, a casing part 3, in which a sun wheel 4 is mounted in each case by a bearing 5, the sun wheel 4 being designed as a plug-in sleeve 6.

The mounted parts A₁ and A₂ of FIGS. 3a and 3b differ from one another somewhat merely in the form and dimensioning of the casing part 3.

In the production of the single-stage gearbox, the engine M is connected directly to the clamping hub 2 or to the mounted part A₁. The hollow shaft wheel of the output stage H_{ab} is attached to the mounted part A₁, said hollow shaft wheel being illustrated in FIG. 5. In this case, the hollow shaft wheel of the output stage H_{ab} has a planet wheel 7 which is in engagement with a sun wheel 8. A planet wheel 9 is mounted in a casing part 10 by bearings 11. The casing part 10 is provided in the outer region with a centering flange 12, onto which the drive shaft A_{W} or output flange A_{F} illustrated in FIGS. 6a and 6b can be plugged.

In FIG. 5, the universal planet-wheel carrier 9 projects somewhat beyond the casing part 10. The output flange A_{F} has a casing part 14 in which a bearing 15 and a flange 16 are provided.

The flange 16 serves for receiving and attaching any desired workpieces and/or tools or for driving any desired loads or the like.

Furthermore, the casing part 14 is provided with a suitable centering flange 17 which fits onto the corresponding centering flange 12 of the hollow shaft wheel of the output stage H_{ab}. If the output flange A_{F} is selected as the output unit A_{E} in the single-stage gearbox, the casing parts 14 and 10 fit exactly one into the other, the bearing 15 of the drive flange A_{F} at the same time forming an additional mounting of the universal planet-wheel carrier 9 of the hollow shaft wheel of the output stage H_{ab}.

In this case, the universal planet-wheel carrier 9 is connected to the flange 16 of the output flange A_{F} nonpositively and/or positively.

If the drive shaft A_{W} is adapted and attached to the hollow shaft wheel H_{ab} in the single-stage gearbox, a casing part 17, as illustrated particularly in FIG. 6b, is attached on the end face to the casing part 10 of the hollow shaft wheel H_{ab}. A shaft 18 is mounted within the casing part 17 via a bearing 19.

It is important, furthermore, in the present invention, that, in the case of the output shaft A_{W} and output flange A_{F}, the embodiment and size of the casing parts 14 and 17 can be varied and designed customer-specifically, as illustrated in FIGS. 6a and 6b. The same also applies to the size and type of the flange 16 or of the shaft 18. If, as illustrated in FIG. 1, a two-stage gearbox is constructed, the engine M and the mounted part A₂ are assembled, as described in FIG. 3b, if appropriate with an adapter plate A_{M} inserted between them, a ring wheel of the drive stage Hₐₙ being inserted between the mounted part A₂ and the hollow shaft wheel H_{ab} of the output stage, as illustrated particularly in FIG. 4. This gearbox has a ring wheel 20 in which a universal planet-wheel carrier 21 carries at least one planet 22 which meshes with a sun wheel 23. At the same time, the universal planet-wheel carrier 21 is in each case formed on both sides of the sun wheel 22 and, on one side, carries a bearing 24 and, on the opposite side, is designed as a plug-in sleeve 25.

In the region of the plug-in sleeve 25, the hollow shaft wheel of the output stage H_{ab} is attached to the ring wheel of the drive stage Hₐₙ, in that the sun wheel 8 is connected positively and/or nonpositively to the universal planet-wheel carrier 21 and an inner region of the universal planet-wheel carrier 9, see FIG. 5, engages into the ring wheel 20 and integrates or supports the ring wheel Hₐₙ of the drive stage.

The ring wheel of the drive stage Hₐₙ can be inserted as what is known as a second stage, in particular prestage, between the mounted part A₂ and the ring wheel of the drive stage Hₐₙ.

During the assembly of the subassemblies A₂ and Hₐₙ in the casing part 3, the bearing 24 of the ring wheel of the drive stage Hₐₙ is mounted or received on a bearing seat 26 of the casing part 3, the subassembly A₂, see FIG. 3b. The sun wheel 4 of the mounted part A₂ is connected positively to the sun wheel 23 of the ring wheel Hₐₙ.

Furthermore, the casing parts 3 and 10 of the mounted part A₁ or the hollow shaft wheel of the output stage H_{ab} can be connected to one another, as illustrated in FIGS. 3b and 5, the ring wheel of the drive stage Hₐₙ being inserted between them in the way described above. The casing parts 3 and 10 can be screwed or welded to one another or else be connected nonpositively or positively to one another.

In order to produce a three-stage gearbox, the subassemblies, engine and, if appropriate, engine adapter plate A_{M}, are connected to the mounted part A₂ (see FIG. 3b) in the way described above, a mounted part A₃ being inserted intermediately between the mounted part A₂ and the above-described ring wheel of the drive stage Hₐₙ. In this case, the mounted part A₃ consists of a casing part 27 which connects the casing part 10 of the hollow shaft wheel of the output stage H_{ab} and the casing part 3 of the mounted part A₂ to one another.

Within the casing part 27 a ring wheel 31 is provided which meshes with a planet 32 seated on a universal planet-wheel carrier 28. At least one planet 32 meshes with a sun wheel 33. Furthermore, a bearing 30 is seated on part of the universal planet-wheel carrier 28. These subassemblies correspond approximately to the construction of the ring wheel of the drive stage Hₐₙ, as indicated in FIG. 4.

If the mounted part A₃ is assembled together with the ring wheel of the drive stage Hₐₙ, the sun wheel 23 engages positively and/or nonpositively into the plug-in sleeve 29 of the planet-wheel carrier 28, the bearing 24 being mounted in a bearing seat of the casing part 27. The universal planet-wheel carrier 28 thereby transmits the torque to the sun 23.

Alternatively, during the connection of the subassemblies A₂ and A₃ to produce the three-stage gearbox, the casing parts 3 and 27 are connected to one another, the bearing 30 engaging into the bearing seat 26, and the sun wheel 33 engaging into the plug-in sleeve 6 of the planet-wheel carrier 4 of the mounted part A2.

An intermediate stage is thereby likewise produced.

In order to produce a TP gearbox with TP kinematics, in particular a two-stage version, the ring wheel 20 of the ring wheel of the drive stage Hₐₙ is connected or screwed to the universal planet-wheel carrier 9 of the hollow shaft wheel H_{ab} of the output stage.

When a gearbox, for example a two-stage gearbox with SP kinematics, is to be produced, then another mounting operation the ring wheel 20 of the ring wheel of the drive stage Hₐₙ is screwed to the stationary casing part 3 of the mounted part A₂, see FIGS. 3b and 4.

An SP or a TP gearbox can thus be assembled by means of the subassemblies Hₐₙ, H_{ab} and A₂ as a result of the different mounting of the individual subassemblies.

1-15. (canceled)

16. A system for producing gearboxes, comprising a plurality of different subassemblies (M, A₁, A₂, A₃, Hₐₙ, H_{ab}, A_{E}, A_{W}, A_{F}), wherein a gearbox having SP kinematics or TP kinematics comprises a plurality of different mounting means for assembling at least one subassembly (Hₐₙ) with at least two of the other subassemblies (H_{ab}) and (A₂).

17. The system as claimed in claim 16, wherein a single-stage gearbox is assembled from the subassemblies, engine (M) mounted part (A_{I}), hollow shaft wheel of an output stage (H_{ab}) and output unit (A_{E}) as an output shaft (A_{W}) or as an output flange (A_{F}) or as a customer-specific drive unit.

18. The system as claimed in claim 17, wherein a two-stage gearbox is assembled from the subassembly, engine (M), a mounted part (A₂), a ring wheel of a drive stage (Hₐₙ), the hollow shaft wheel of the output stage (H_{ab}) and a subsequent output unit (A_{E}).

19. The system as claimed in claim 18, wherein a further mounted part (A₃) is inserted between the mounted part (A₂) and the ring wheel of the drive stage (Hₐₙ).

20. The system as claimed in claim 18, wherein the ring wheel of the drive stage (Hₐₙ) has a ring wheel (20) into which a sun wheel (23), a universal planet-wheel carrier (21) and planets (22) are inserted.

21. The system as claimed in claim 18, wherein the hollow shaft wheel of the output stage (H_{ab}) is formed from a casing part (10) with universal planet-wheel carrier (9) and inserted planet (7) and sun wheel (8).

22. The system as claimed in claim 18, wherein the mounted parts (A₁) and (A₂) are formed from a casing part (3) with a clamping hub (2) inserted via bearings (5), having a sun wheel (3) with an integrated plug-in sleeve (6).

23. The system as claimed in claim 18, wherein, in order to produce a gearbox with TP kinematics, the ring wheel (20) of the ring wheel of the drive stage (Hₐₙ) is connected fixedly to a universal planet-wheel carrier (9) of the hollow shaft wheel of the output stage (H_{ab}).

24. The system as claimed in claim 18, wherein, in order to produce an SP gearbox with SP kinematics, the ring wheel (20) of the ring wheel of the drive stage (Hₐₙ) is connected fixedly to a casing part (3) of the mounted part (A₂).

25. The system as claimed in claim 19, wherein the mounted part (A₃) is formed from a casing part (27) into which a ring wheel (31) having an integrated planet (32), universal planet-wheel carrier (28) and sun wheel (33) is integrated, the planet-wheel carrier (28) having a plug-in sleeve (29) on one side.

26. The system as claimed in claim 20, wherein, in order to produce two-stage TP gearboxes, the ring wheel (20) of the ring wheel of the drive stage (Hₐₙ) is connected fixedly in terms of rotation to the universal planet-wheel carrier (9) of the hollow shaft wheel (H_{ab}).

27. The system as claimed in claim 20, wherein, in order to produce a two-stage SP gearbox, the ring wheel (20) of the ring wheel of the drive stage (Hₐₙ) is connected fixedly to the casing (3) of the mounted part (A₂).

28. The system as claimed in claim 19, wherein, in order to produce a three-stage TP or SP gearbox, a ring wheel (31) of the mounted part (A₃) is connected fixedly to the casing part (3) of the mounted part (A₂), and the ring wheel (20) of the ring wheel of the drive stage (Hₐₙ) is connected fixedly to the casing part (27) of the mounted part (A₃).

29. The system as claimed in claim 19, wherein, in order to produce a three-stage TP or SP gearbox, the ring wheel (20) of the drive stage (Hₐₙ) is connected on the right to the output stage (H_{ab}) or on the left to the casing part (27) of the mounted part (A₃).

30. The system as claimed in claim 19, wherein, in order to produce a three-stage TP or SP gearbox, a ring wheel (31) of the mounted part (A₃) is connected on the right to the casing part (27) of the mounted part (A₃) or on the left to the casing part (3) of the mounted part (A₂).
